(19) United States
(12) Patent Application Publication
(10) Pub. No.: US 2016/0219464 A1
(43) Pub. Date: Jul. 28, 2016

(54) METHODS, NETWORK NODES AND USER EQUIPMENTS FOR IMPROVING HANDOVER IN A COMMUNICATION NETWORK COMPRISING A 3GPP ACCESS NETWORK AND A NON-3GPP ACCESS NETWORK

(71) Applicant: Telefonaktiebolaget L M Ericsson (publ), Stockholm (SE)

(72) Inventors: Dinand Roeland, Sollentuna (SE); Jari VIKBERG, JÄRNA (SE); Stefan ROMMER, VÄSTRA FRÖLUNDA (SE); Tomas HEDBERG, STOCKHOLM (SE)

(21) Appl. No.: 14/438,196

(22) PCT Filed: Dec. 17, 2014
(86) PCT No.: PCT/SE2014/051520

§ 371 Date: Apr. 23, 2015

Related U.S. Application Data
(60) Provisional application No. 62/076,675, filed on Nov. 7, 2014.

(51) Int. Cl. H04W 36/00; H04W 36/18; H04W 36/38

(52) U.S. Cl. CPC H04W 36/0022; H04W 36/38; H04W 36/18; H04W 80/04

(57) ABSTRACT

A method of a PGW may improve handover in a network including a 3GPP access network and a non-3GPP access network. For a UE, an IP flow mobility PDN connection is may be set up towards the network. Information may be obtained that for the IP flow mobility PDN connection, there is a first bearer in a first access network, which first bearer has an access parameter with a first value, the first access network being either the non-3GPP access network or the 3GPP access network. Setup of a second bearer may be triggered in a second access network that has an access parameter with the first value, when, for the IP flow mobility PDN connection, there is no bearer that has an access parameter with the first value in the second access network.

### TECHNICAL FIELD

The present disclosure relates generally to methods, network nodes and user equipments for improving handover in a communication network comprising a 3GPP access network and a non-3GPP access network.

### BACKGROUND

FIG. 1 is an overview of an evolved packet system, EPS, architecture 100 comprising evolved packet core, EPC, and a number of radio access networks connected to the EPC, as defined in specification 3^{rd} Generation Partnership Program, 3GPP, TS 23.401. To this core network, different 3GPP defined access networks may be connected, such as an Evolved Universal Mobile Telecommunication System, UMTS, Terrestrial Radio Access Network, E-UTRAN 150, a UTRAN 160 and a GSM Edge Radio Access Network, GERAN 170. The radio access networks GERAN, UTRAN and E-UTRAN each comprises a number of base stations: base transceiver stations, BTS, nodeBs and eNodeBs, respectively (not shown) to which a user equipment, UE 120 may be connected. In addition, GERAN and UTRAN comprise also radio access network controllers: base station controllers, BSC, and radio network controllers, RNC, respectively (not shown). The UE 120 may be any kind of device that is enabled to be wirelessly connected via a 3GPP access network such as the E-UTRAN 150, the UTRAN 160 or the GERAN 170, such as a mobile phone, laptop etc. The EPC comprises a Mobility Management Entity, MME 102 connected to the E-UTRAN, a Serving Gateway, SGW 104 connected to the E-UTRAN, the MME and the UTRAN. The EPC further comprises a Packet Data Network, PDN, gateway, PGW 110 connected to the SGW, and a Policy Charging and Rules Function, PCRF 108, which functions as a policy controller, connected to the PGW. Further, to the PGW 110 and the PCRF 108 a packet data network 112 may be connected over which one or more operators' IP services may be provided to UEs via the EPC and the 3GPP access networks.

FIG. 2 shows an extension to the EPS architecture in order to allow also non-3GPP accesses. The extension is specified in 3GPP TS 23.402. In a non-3GPP network the radio interface is not specified by the 3GPP. An example of a non-3GPP network is WLAN. In the figure, some functionality belongs to the 3GPP network whereas some belong to the non-3GPP network. In FIG. 2, the 3GPP network may be a Home Public Land Mobile Network, HPLMN for the UE 120. The HPLMN may identify the PLMN, Public Land Mobile Network, in which the profile (also known as the subscription) of the subscriber owning the UE is held.

A non-3GPP access network may be trusted or untrusted. The exact definition of trusted or untrusted is given in the 3GPP specifications. Simplified, one can say that a trusted access network 180 is managed by an operator, e.g. an operator hotspot that is also managing the HPLMN or an operator that in some way co-operates with the HPLMN operator, whereas an untrusted access network 190 is not managed by the operator, e.g. a WiFi access point at home. For the non-3GPP access network, a security gateway called evolved Packet Data Gateway, ePDG 130 is used between the untrusted access network 190 and the 3GPP network. The UE 120 is arranged to set up a secure tunnel to the ePDG, and between the ePDG 130 and the PGW 110 there is an S2b interface. A trusted 3GPP access network 180 hosts a gateway, e.g. a Trusted Wireless Access Gateway, TWAG 185, defined in 3GPP TS 23.402 section 16. There is a point-to-point interface between the UE and the TWAG, and between the TWAG 185 and the PGW 110 there is an S2a interface.

3GPP defines the concept of a Packet Data Network, PDN. A PDN is in most cases an IP network, e.g. the Internet or an operator IP-based Multimedia Services, IMS, service network. A PDN has one or more names; each name is defined in a string called Access Point Name, APN. The PGW 110 is a gateway towards one or more PDNs. A UE may have one or more PDN connections. A PDN connection is a logical IP tunnel between the UE and the PGW, providing the UE access to a PDN. The setup of a PDN connection is initiated from the UE. Each PDN connection has a single IP address or prefix.

PDN connections can be setup over a 3GPP access or over a non-3GPP access. A UE may have one or more PDN connections over a 3GPP access, or one or more PDN connections over a non-3GPP access, or both simultaneously. Every PDN connection comprises one or more bearers. A bearer uniquely identifies traffic flows that receive a common QoS treatment between a UE and the PGW. Each bearer on a particular access has a unique bearer ID. The bearer IDs assigned for a specific UE on S2a/S2b are independent of the bearer IDs assigned for the same UE on S5 and may overlap in value. S5 is the 3GPP-interface between the PDN gateway 110 and the Serving gateway 104.

On the 3GPP access, the bearer is end-to-end between the UE and the PGW 110. The bearer ID is known by the PGW, the MME 102, the eNodeB and the UE 120. On the non-3GPP access, there is no bearer concept between the UE and the TWAG/ePDG. The bearer concept is only defined between the PGW and the TWAG/ePDG; i.e. it is only defined over S2a/S2b. In this case, the bearer ID is known by the PGW and the TWAG/ePDG but not by the UE. Regardless of access type, the PCRF 108 is not aware of bearer IDs. Every PDN connection has at least one bearer and this bearer is called the default bearer. All additional bearers on the PDN connection are called dedicated bearers.

A bearer carries traffic in the form of IP packets. Which traffic is carried on a bearer is defined by filters. A filter is an n-tuple where each element in the tuple contains a value, a range, or a wildcard. An n-tuple is also known as an IP flow. An example of a 5-tuple is: [dst IP=83.50.20.110, src IP=145.45.68.201, dst port=80, src port=*, prot=TCP]. This 5-tuple defines a source and destination IP address, a source and destination port, and a protocol. The source port is a wildcard. Traffic matching this 5-tuple filter would be all TCP traffic from IP address 145.45.68.201 to IP address 83.50.20.110 and destination port 80. A traffic flow template, TFT, contains one or more filters. Every bearer has a TFT. One bearer within a PDN connection and access may lack an explicit TFT, this bearer is typically the default bearer. Implicitly, such a bearer has a TFT with a single filter matching all packets.

IFOM is defined in 3GPP TS 23.402 and stands for IP flow mobility. An IFOM PDN connection is a special PDN connection that still has a single IP address/prefix but is routed over multiple accesses simultaneously. The UE and the PGW negotiate which IP flow that gets routed over which access. Even though an IFOM PDN connection may be routed over multiple accesses simultaneously, the bearers on each access within that PDN connection are independent of each other. In order to negotiate which IP flow shall be routed over which access, routing rule update procedures are being defined. A routing rule update can be initiated either from the UE or from the PGW. Exemplary call flows for network-initiated routing rule update procedures for S2a can be found in http://www.3gpp.org/ftp/tsg_sa/WG2_Arch/TSGS2_104_Dublin/Docs/S2-142364.zip. Exemplary call flows for network-initiated and UE-initiated routing rule update procedure for S2a and S2b can be found in http://www.3gpp.org/ftp/tsg_sa/WG2_Arch/TSGS2_104_Dublin/Docs/S2-142449.zip.

Handover procedures between LTE and WLAN are defined in 3GPP TS 23.402 section 16.10 and 16.11. These handover procedures are on a granularity of a PDN connection. If a UE has multiple PDN connections towards the same

APN, the procedure is repeated for that group of PDN connections. The procedures are initiated by the UE. A trigger for the UE to attach to WLAN and to initiate a handover procedure may come e.g. from an Access Network Discovery and Selection Function, ANDSF, which is a policy database in the network. ANDSF policies may contain thresholds that are sent from a radio access network,

RAN node in the 3GPP network to the UE. For a UE that has both LTE and WLAN radio capability, the ANDSF defines Inter-System Routing Policy, ISRP rules. In 3GPP TS 23.402 the following is specified: The ISRP rules are a set of operator-defined rules that determine how the UE should route IP traffic across multiple radio access interfaces. The ANDSF may provide a list of ISRP rules to the UE independently of the UE capability to route IP traffic simultaneously over multiple radio access interfaces. The UE uses the ISRP rules when it can route IP traffic simultaneously over multiple radio access interfaces, e.g. it is an IFOM capable LIE with the IFOM capability enabled or a Multi Access PDN Connectivity, MAPCON capable UE with the MAPCON capability enabled.

It is in today's 3GPP specifications not possible for the RAN to send a handover command to the UE in order to instruct the UE to handover to another radio access technology. In current EPS systems, a control entity in the RAN decides when the UE shall perform a handover from one LTE base station, i.e. eNodeB, to another LTE base station. Such control entity may be co-located with an eNodeB. The control entity is aware of bearers but not of PDN connections or IP flows.

Work is ongoing in 3GPP Rel-12 to enable that a UE may be connected to multiple LTE base stations at the same time. This work is known as “LTE Dual Connectivity”. Two different architecture principles are being standardized. The first principle can be called “Serving GW split” i.e. that specific data bearers can be routed to different base stations from the serving gateway, SGW. E.g. the UE may have a single PDN connection and two bearers. Initially both bearers are routed via a macro LTE cell. Then the UE connects to a small cell, while staying connected to the macro cell. RAN can then decide to handover one of the two bearers to the small cell. The other principle can be called “Main eNB bearer split” and in this case a Main eNB receives all traffic from the SGW and decides how and via which base station the traffic should be sent to the UE. This latter solution works also for a single data bearer for a specific UE. One common part for both the above principles is that RAN (called as Main eNB in the LTE Dual

Connectivity work) is in control of how the UE is connected to the multiple LTE base stations and how traffic is sent to and from the UE.

When performing handover between LTE and WLAN, there is no possibility to do this RAN-controlled of the UE connection on a per-bearer granularity. Only handover on a per-APN basis is defined today in the 3GPP specifications. One problem is that there are no bearers over WLAN. Another problem is that RAN is only aware of bearers, not of PDN connection or IP flows.

### SUMMARY

It is an object of the invention to address at least some of the problems and issues outlined above. It is another object of the present invention to provide a solution where bearer-based handover between LTE and WLAN is made possible. This should preferably be achieved without having to introduce bearers over the WLAN air interface, and without having to introduce IP awareness in RAN. The basic idea for achieving this object is to use IFOM with symmetrical bearers.

According to an aspect, a method is provided, performed by a packet data network gateway, PGW, for improving handover in a communication network comprising a 3GPP access network and a non-3GPP access network, and wherein, for a UE, an IP flow mobility Packet Data Network, PDN, connection is set up towards the communication network. The method comprises: obtaining information that for the IP flow mobility PDN connection, there is a first bearer in a first access network, which first bearer has an access parameter with a first value, the first access network being either the non-3GPP access network or the 3GPP access network, and when, for the IP flow mobility PDN connection, there is no bearer that has an access parameter with the first value in a second access network, triggering setup of a second bearer in the second access network that has an access parameter with the first value, the second access network being either the non-3GPP access network or the 3GPP access network but not the same access network as the first access network.

According to another aspect, a method is provided for improving handover performed by a UE configured to communicate with a communication network comprising a 3GPP access network and a non-3GPP access network, the UE having an IP flow mobility Packet Data Network, PDN, connection set up towards the communication network. For the IP flow mobility PDN connection there is a first bearer in a first access network, which first bearer has an access parameter with a first value, the first access network being the 3GPP access network, and a second bearer in a second access network that has an access parameter with the first value, the second access network being the non-3GPP access network. The method comprises receiving a handover command from a 3GPP access network node to handover IP flows associated with the first bearer of the first access network to a target access network, the target access network being either the 3GPP access network or the non-3GPP access network, the handover command containing an indicator identifying the first bearer and a target access network indicator. The method further comprises, in response to the received handover command, sending an IP Flow handover request to a PDN gateway, instructing the PDN gateway to start sending IP flows associated with the first bearer to the target access network.

According to another aspect, a PGW is provided, operable in a communication network comprising a 3GPP access network and a non-3GPP access network, and wherein, for a UE, an IP flow mobility PDN connection is set up towards the communication network. The PGW comprises a processor and a memory. The memory contains instructions executable by said processor, whereby the PGW is operative for obtaining information that for the IP flow mobility PDN connection, there is a first bearer in a first access network, which first bearer has an access parameter with a first value, the first access network being either the non-3GPP access network or the 3GPP access network; and when, for the IP flow mobility PDN connection, there is no bearer that has an access parameter with the first value in a second access network, triggering setup of a second bearer in the second access network that has an access parameter with the first value, the second access network being either the non-3GPP access network or the 3GPP access network but not the same access network as the first access network.

According to another aspect, a UE is provided configured to communicate with a communication network comprising a 3GPP access network and a non-3GPP access network, the UE having an IP flow mobility PDN connection set up towards the communication network. For the IP flow mobility PDN connection there is a first bearer in a first access network, which first bearer has an access parameter with a first value, the first access network being the 3GPP access network, and a second bearer in a second access network that has an access parameter with the first value, the second access network being the non-3GPP access network. The UE comprises a processor and a memory. The memory contains instructions executable by said processor, whereby the UE is operative for receiving a handover command from a 3GPP access network node to handover IP flows associated with the first bearer of the first access network to a target access network, the target access network being either the 3GPP access network or the non-3GPP access network, the handover command containing an indicator identifying the first bearer and a target access network indicator; and in response to the received handover command, sending an IP Flow handover request to a PDN gateway, instructing the PDN gateway to start sending IP flows associated with the first bearer to the target access network.

According to other aspects, computer programs and carriers are also provided, the details of which will be described in the claims and the detailed description.

### BRIEF DESCRIPTION OF DRAWINGS

The solution will now be described in more detail by means of exemplary embodiments and with reference to the accompanying drawings, in which:

FIG. 1 is a schematic block diagrams illustrating an EPC architecture comprising different 3GPP access networks.

FIG. 2 is a schematic block diagrams illustrating an evolved EPC architecture comprising a 3GPP access network and two non-3GPP access networks.

FIG. 3 is a flow chart of a method performed by a PDN gateway according to embodiments of the invention.

FIG. 4 is a flow chart of a method performed by a UE according to embodiments of the invention.

FIGS. 5a-5c are schematic block diagrams of three alternative embodiments of performing IFOM handover.

FIGS. 6a-6b are schematic signaling diagrams illustrating signals sent for IFOM handovers.

FIGS. 7-8 are schematic block diagrams of PDN gateways according to different embodiments.

FIGS. 9-10 are schematic block diagrams of UEs according to different embodiments.

### DETAILED DESCRIPTION

Today, the RAN controls the handover of bearers within the 3GPP access, e.g. within the LTE domain. It is today not possible for RAN to do bearer-based handover between a 3GPP access network and a non-3GPP access network, e.g. between LTE and WLAN. In other words, it is not possible for the RAN, nor for the PGW, to handover a single bearer between LTE and WLAN while keeping other bearers of that same PDN connection on the original access. Note that it is possible today to handover a complete PDN connection, or rather all PDN connection for a UE to the same APN, between LTE and WLAN.

As shown, a solution for doing bearer-based handover between a 3GPP access network and non-3GPP access network would be needed; i.e. similar to what is possible today within the 3GPP access. One way to achieve such a solution is to use IFOM. But a problem with an IFOM-based solution for bearer handover is that the concept of bearers is not available over the non-3GPP access network air interface, e.g. WLAN air interface. The bearer concept for WLAN is only defined between the PGW and the access gateway in the WLAN. This disclosure describes an IFOM-based solution for bearer-based handover between a 3GPP access network and a non-3GPP access network where no bearer concept over the non-3GPP access network e.g. the WLAN access network needs to be introduced.

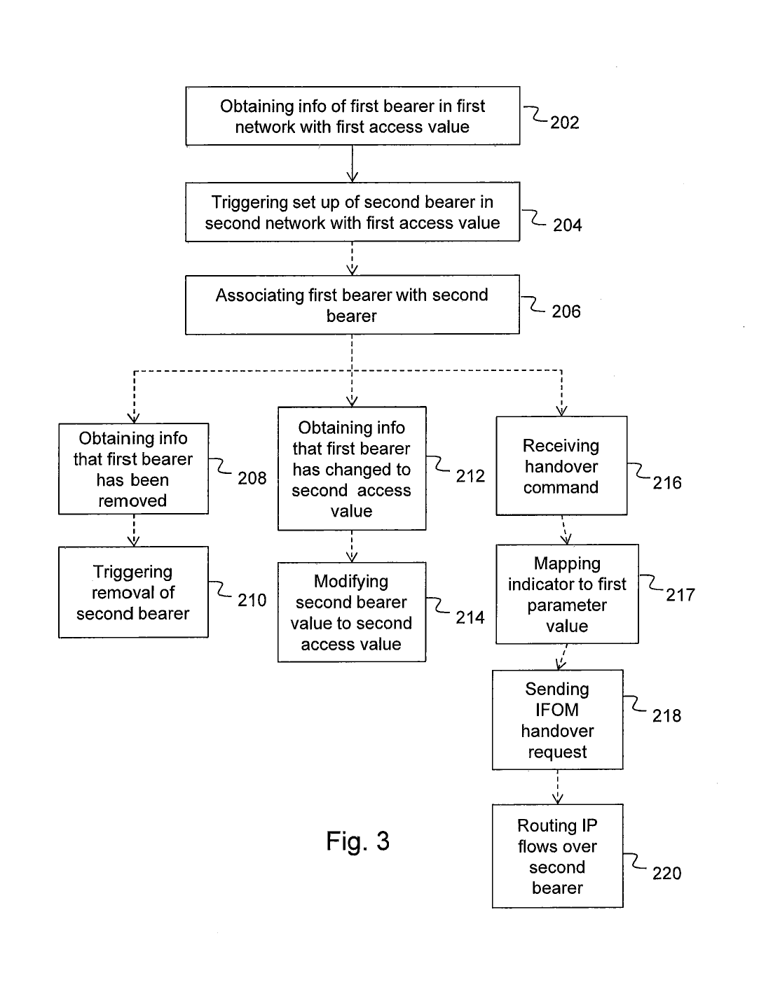

According to an embodiment of the invention as shown in FIG. 3, a method is provided performed by a PGW 110, for improving handover in a communication network comprising a 3GPP access network 150, 160, 170 and a non-3GPP access network 180, 190, and wherein, for a UE 120, an IP flow mobility Packet Data Network, PDN, connection is set up towards the communication network. The method comprises: obtaining 202 information that for the IP flow mobility PDN connection, there is a first bearer in a first access network, which first bearer has an access parameter with a first value, the first access network being either the non-3GPP access network or the 3GPP access network, and when, for the IP flow mobility PDN connection, there is no bearer that has an access parameter with the first value in a second access network, triggering 204 setup of a second bearer in the second access network that has an access parameter with the first value, the second access network being either the non-3GPP access network or the 3GPP access network but not the same access network as the first access network.

The access parameter may be one or more of Quality of Service Class Identifier (QCI), Allocation and Retention Priority (ARP), Maximum Bit Rate (MBR), Guaranteed Bit Rate (GBR), Charging Id, Traffic Flow Template, TFT.

A 3GPP access network is an access network that is built on a technology standardized by 3GPP. Such technologies are e.g. the Global System for Mobile Communications, GSM, including GSM evolved radio access technologies, e.g. General Packet Radio Service, GPRS and Enhanced Data Rates for GSM Evolution, EDGE, evolved third Generation, 3G, and beyond mobile systems such as Long Term Evolution, LTE, and radio access technologies such as UMTS Terrestrial Radio Access, UTRA. A non-3GPP access network is an access network that is built on a technology not standardized by 3GPP, more specifically a generic framework for a network of which the radio access is not defined by 3GPP. However, 3GPP may standardize how to interface these networks with the 3GPP network. Such a network may be e.g. a Wireless Local Area Network, WLAN or a CDMA2000 network. The second access network may be more than one access network.

By such a method as the one described above it is possible to perform handover between a non-3GPP network and a 3GPP network of IP flows of only a single bearer in an IP flow mobility PDN connection that comprises more than one bearer. With prior art technology it is only possible to perform handover between a non-3GPP network and a 3GPP network of a whole PDN connection comprising all it's bearers.

According to an embodiment, the method further comprises, in response to the set-up of the second bearer with the first value, associating 206 the first bearer of the first access network with the second bearer of the second access network. The first bearer may be associated with the second bearer by e.g. linking the first bearer to the second bearer and storing the link in e.g. a storage, e.g. as a look-up table. The PGW may then check the association, e.g. in the look-up table when e.g. obtaining information that the first bearer has been removed or information that the access parameter value of the first bearer has been changed.

According to another embodiment, the method further comprises, after the first bearer has been associated 206 with the second bearer: obtaining 208 information that the first bearer has been removed; and triggering 210 removal of the second bearer in response to the obtained information.

According to another embodiment, the method further comprises, after the first bearer has been associated 206 with the second bearer: obtaining 212 information that the access parameter value of the first bearer has been changed to a second value, and in response to the obtained change information, modifying 214 the access parameter value of the second bearer from the first value to the second value.

According to another embodiment, the method further comprises: receiving 216 a handover command from a 3GPP access network node to handover IP flows associated with the first bearer of the first access network to the second access network, the handover command containing an indicator identifying the first bearer and a second access network indicator, mapping 217 the received indicator identifying the first bearer to the first access parameter value, sending 218 an IP flow handover request to the UE, instructing the UE to start sending IP flows matching the first access parameter value to the second access network according to the second access network indicator, and when receiving an IP flow matching the first access parameter value, routing 220 this IP flow on the second bearer of the second access network, the second bearer having the first access parameter value.

The handover command may be received from any 3GPP network node such as the PCRF or a 3GPP Radio Access Network node. The term “IP flows associated with the first bearer” may be all IP flows associated with the first bearer. The IP flow handover request sent by the PGW to the UE may be an IP flow mobility routing rule update. The IP flow handover request sent to the UE may comprise an ID of the second bearer of the second access network and/or routing rules comprising IP flow filters. The routing 220 of the IP flow over the second bearer may be performed in response to receiving a positive response from the UE to the sent 218 IP flow handover request. The indicator identifying the first bearer may be a bearer-ID. The indicator identifying the first bearer may also be the access parameter value, such as a first TFT. The mapping 217 makes it possible to connect the identifier, e.g. the bearer Id to the access parameter value, e.g. the TFT. In case the identifier is the first access parameter value, such a mapping will not be needed.

The 3GPP network node may not know the first access parameter value so it can just send the bearer-ID of the first bearer. Therefore, the PGW performs a mapping between first bearer-ID and first access parameter value according to a stored connection/association. As the second bearer has the same access parameter value as the first bearer, the PGW knows which bearer that is the second bearer when it knows the access parameter value of the first bearer, and consequently the PGW can route the IP flow on the second bearer to the second access network. According to another embodiment, it may be that the 3GPP network node does not know the bearer-ID, and therefore only sends the first access parameter (e.g. TFT). Then the PGW performs a mapping between the first access parameter value and the first bearer-ID according to a stored connection/association and sends the first bearer-ID to the UE, which in turn maps the first bearer-ID back to the first access parameter.

According to an embodiment, the handover command is received from a radio access network node of the 3GPP access network. According to another embodiment, the handover command is received from a Policy and Charging Rule Function, PCRF, of the 3GPP network.

According to an embodiment, the method further comprises: receiving an IP flow handover request from the UE to handover IP flows associated with the first bearer of the first access network to the second access network, the handover request containing an indicator identifying the first bearer and a second access network indicator, mapping the received indicator identifying the first bearer to the first access parameter value, sending an acknowledgement to the UE, instructing the UE to start sending IP flows matching the first access parameter value to the second access network, and when receiving an IP flow matching the first access parameter value, routing this IP flow on the second bearer having the first access parameter value.

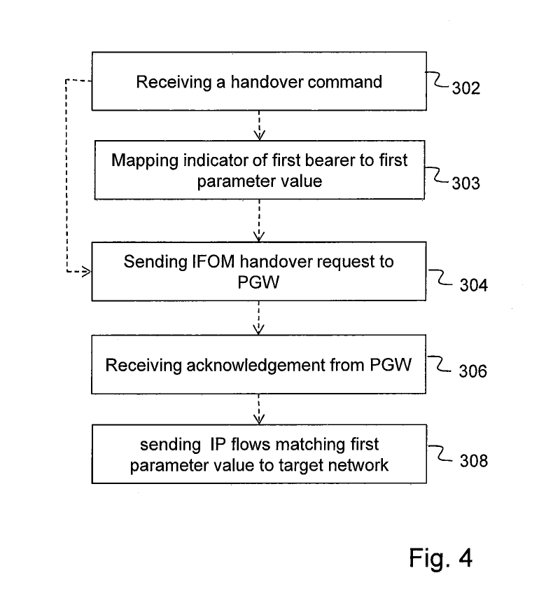

According to another aspect of the invention, as shown in FIG. 4, a method is provided for improving handover performed by a UE 120, configured to communicate with a communication network comprising a 3GPP access network 150, 160, 170 and a non-3GPP access network 180, 190, the UE having an IP flow mobility PDN connection set up towards the communication network. For the IP flow mobility PDN connection there is a first bearer in a first access network, which first bearer has an access parameter with a first value, the first access network being the 3GPP access network, and a second bearer in a second access network that has an access parameter with the first value, the second access network being the non-3GPP access network. The method comprises: receiving 302 a handover command from a 3GPP access network node to handover IP flows associated with the first bearer of the first access network to a target access network, the target access network being either the 3GPP access network or the non-3GPP access network, the handover command containing an indicator identifying the first bearer and a target access network indicator; and in response to the received handover command, sending 304 an IP Flow handover request to a PDN gateway, instructing the PDN gateway to start sending IP flows associated with the first bearer to the target access network.

The indicator identifying the first bearer can be used also to move traffic back to the 3GPP access network from the non-3GPP access network as the first bearer is maintained in the 3GPP access network even when the IP flows on that bearer would have previously been moved to the non-3GPP access network. The target access network indicator is used for indicating the identity of the target access network, i.e. either the 3GPP network or the non-3GPP network.

According to an embodiment, the sent handover request 304 contains the indicator identifying the first bearer and the target access network indicator. According to another embodiment, the method further comprises mapping 303 the received indicator identifying the first bearer to the first access parameter value.

According to another embodiment, the method further comprises receiving 306 an acknowledgement from the PDN Gateway in response to the sent IP Flow handover request, and sending 308 an IP flow matching the first access parameter value to the target access network, in response to the received acknowledgement.

An idea of the invention is that the PGW ensures that for each bearer within an IFOM PDN connection on a first access network, e.g. over an S5 interface between the SGW 104 and the PGW 110, there is a counterpart bearer on a second access network, e.g. over an S2a/S2b interface between the PDN gateway and the ePDG 130 and/or the TWAG 185, which counterpart bearer has the same TFT as the bearer on the first access network. This concept is here called symmetrical bearers. If the TFT for a specific bearer changes, then the PGW ensures that the same change is also performed on the counterpart bearer. According to embodiments, this may signify one or more of the following: Assume a new dedicated bearer within a first access of an IFOM PDN connection is setup. The PGW then also sets up a dedicated bearer in all other accesses of that same IFOM PDN connection, each bearer having the same TFT as the one in the first access; Assume a new access is added to an existing IFOM PDN connection. Then the PGW sets up default and dedicated bearers in that new access such that the set of bearer is identical to the set of bearers in the other accesses of the IFOM PDN connection. Identical means that the number of bearers is the same, and that for each bearer in the other access there is a corresponding bearer with the same TFT in the new access; Assume that the TFT for a bearer in a first access of an IFOM PDN connection is modified. Then the PGW also makes the same modifications for each bearer in all other accesses of that same IFOM PDN connection that shares the same TFT; Assume that a dedicated bearer within a first access of an IFOM PDN connection is removed. The PGW then also removes the corresponding dedicated bearer(s) in all other accesses of that same IFOM PDN connection, each bearer having the same TFT as the one in the first access.

Symmetrical bearers may signify that every access of the IFOM PDN connection has the same number of bearers, and for each bearer in a first access of the IFOM PDN connection there is a bearer in all other accesses of the IFOM PDN connection with the same TFT.

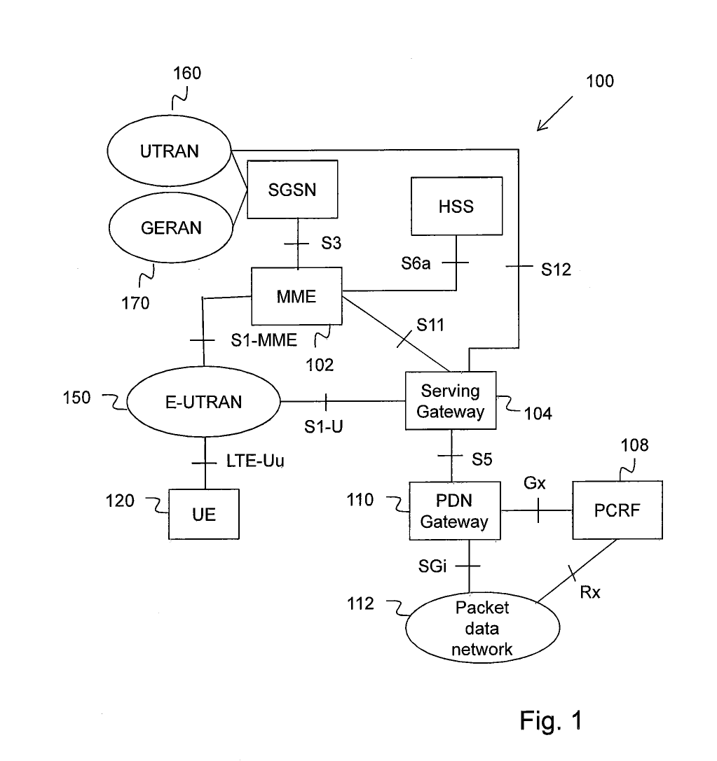

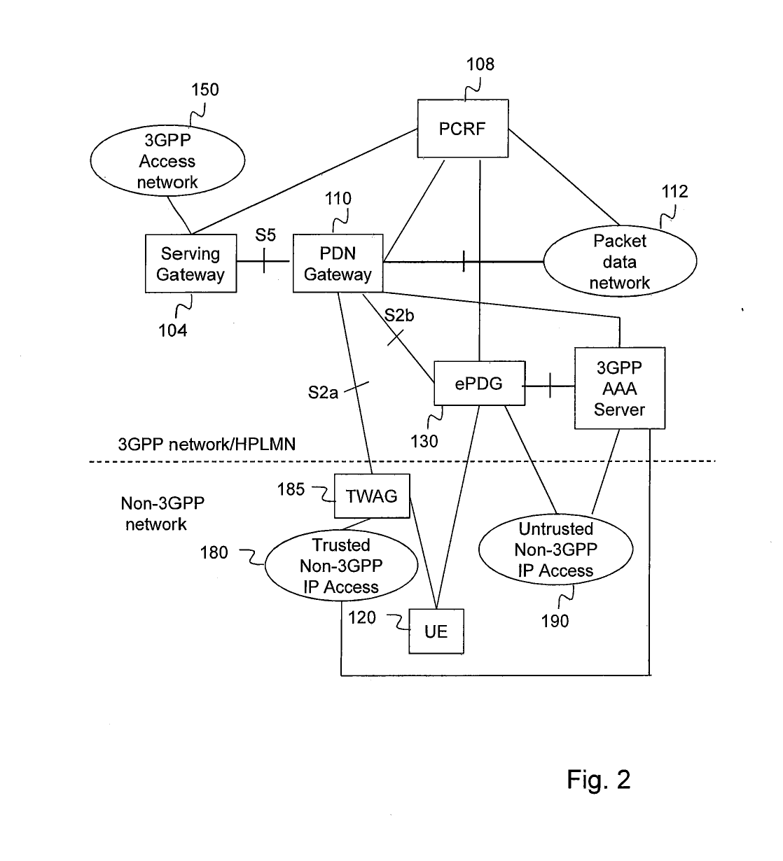

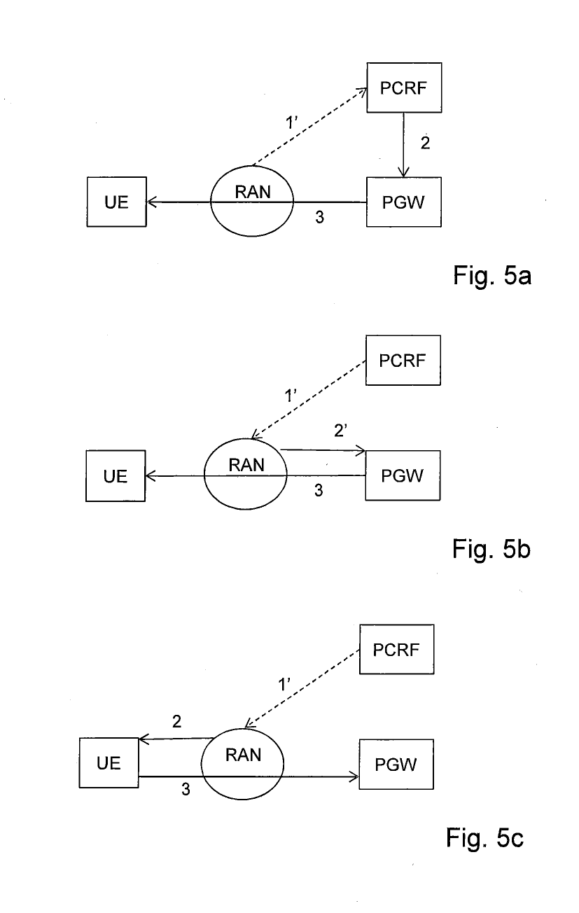

FIGS. 5a-5c show three alternative embodiments for RAN-controlled bearer-based handover, in other words, high-level procedures on how to do handover controlled from the network using IFOM. The EPC architecture from 3GPP TS 23.401 is assumed although FIGS. 5a-5c are simplified compared to FIG. 1 that shows the whole EPS architecture. “RAN” encompasses access network nodes like eNodeBs. In this picture, we could also see the MME as being part of the RAN. RAN may also include a control entity that makes handover decisions. The interfaces marked in FIGS. 5a-5c with regular numbers are standardized, and the interfaces marked with regular numbers followed by a ′ (e.g. 1′) could be non-standardized interfaces.

In the embodiment of FIG. 5a, also called embodiment A, the following steps are performed: Step 1′ (optional): RAN triggers PCRF to initiate handover of IP flow(s); Step 2: PCRF triggers PGW to initiate handover of IP flow(s), if step 1′ is used, in response to the received trigger from the RAN; Step 3: PGW performs a network-initiated IFOM routing rule update procedure, in response to the received trigger from the PCRF. Step 3 may be performed over the RAN, as shown, but it is also possible to perform step 3 over the WLAN.

In the embodiment of FIG. 5b, also called embodiment B, the following steps are performed: Step 1′ (optional): PCRF provides input information to RAN related to handover of IP flow(s); Step 2′: RAN triggers PGW to initiate handover of IP flow(s). If step 1′ is used, step 2′ is performed in response to the received input information of step 1′. However, step 2′ may be performed also without step 1′. Step 3: PGW performs a network-initiated IFOM routing rule update procedure, in response to the received trigger.

In the embodiment of FIG. 5c, also called embodiment D, the following steps are performed: Step 1′ (optional): PCRF provides input information to RAN related to handover of IP flow(s); Step 2: RAN triggers the UE to initiate handover of bearer(s). If step 1′ is used, step 2 is performed in response to the received input information of step 1′. However, step 2 may be performed also without step 1′. Step 3: UE performs a UE-initiated IFOM routing rule update procedure, in response to the received trigger.

Another possible embodiment, called embodiment C, not shown here, is a combination of A and B where the PGW receives input from both PCRF and RAN. This embodiment is not further described in this document.

RAN-controlled bearer-based handover in embodiment D

In embodiment D a RAN-controlled bearer-based handover may be achieved as follows. A control entity in RAN may decide that a particular bearer is to be handed over from a first access network to a second access network. In the following a procedure when handing over from an LTE network to a WLAN is shown. RAN sends a command “handover bearer ID=x to WLAN” to the UE, step 2 in FIG. 5c. Such command could be sent from an eNB to the UE. The UE maps bearer ID=x to the TFT of that bearer and thereby the set of IP flows for this bearer. The UE then performs a UE-initiated IFOM routing rule update towards the PGW, step 3 in FIG. 5c. The routing rule either includes a set of, or all, IP flows of bearer ID=x and an indication that these IP flows are to be handed over to WLAN, or the routing rule includes bearer ID=x and an indication that the IP flows of this bearer are to be handed over to WLAN. In that case the PGW maps the ID=x of this bearer to the TFT and the set of IP flows of this bearer. Either way, after acknowledgement from the PGW, both the UE and the PGW will route all IP flows associated with the bearer indicated by the RAN control entity over WLAN.

In the procedure above, both the UE and a RAN node, e.g. an LTE node, e.g. a RAN control entity are aware of the bearers over LTE radio and S1; the bearer ID is known to both the UE and the RAN control entity. In the other handover direction, from WLAN to LTE, the UE is not aware of the S2a/S2b bearer ID. There are no bearers over WLAN between the UE and the TWAG/ePDG.

However, with the concept of symmetrical bearers, the RAN control entity can still instruct the UE to handover on a per-bearer basis, even in the WLAN-to-LTE direction. The control entity could, in the example above, simply store a relation “traffic for bearer ID=x currently on WLAN”. When a decision is made in the RAN to “take back” the traffic of that bearer to LTE, e.g. when there is available bandwidth, then the control entity sends a command “handover bearer ID=x to LTE” (step 2 in embodiment D). The rest of the procedure is the same as described above in the handover direction LTE to WLAN. The UE and/or PGW map ID=x to the TFT of that bearer. Due to the symmetrical-ness, there is a corresponding bearer with ID=y on S2a/S2b with the same TFT. So the routing rule update that is sent from UE to PGW will ensure that all traffic from the S2a/S2b bearer with ID=y is moved to the S5/S1/LTE bearer with ID=x. After handover, the control entity updates the relation to “traffic for bearer ID=x currently on LTE”.

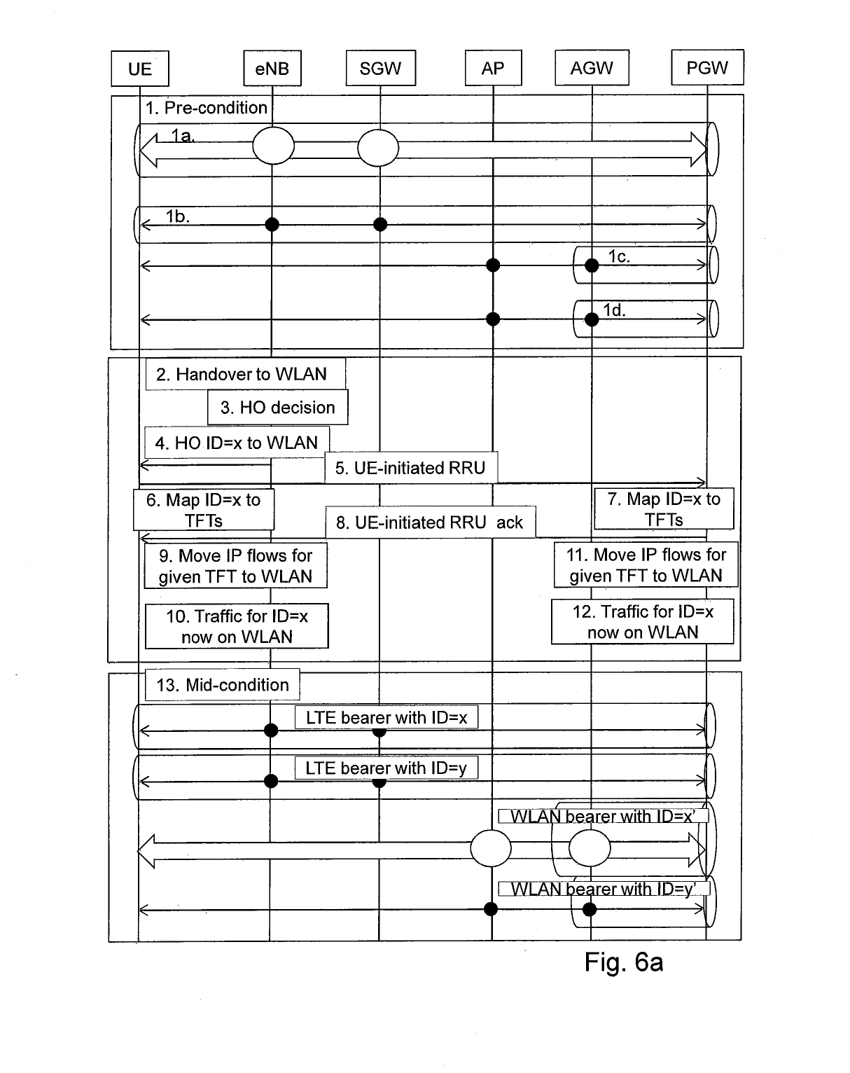

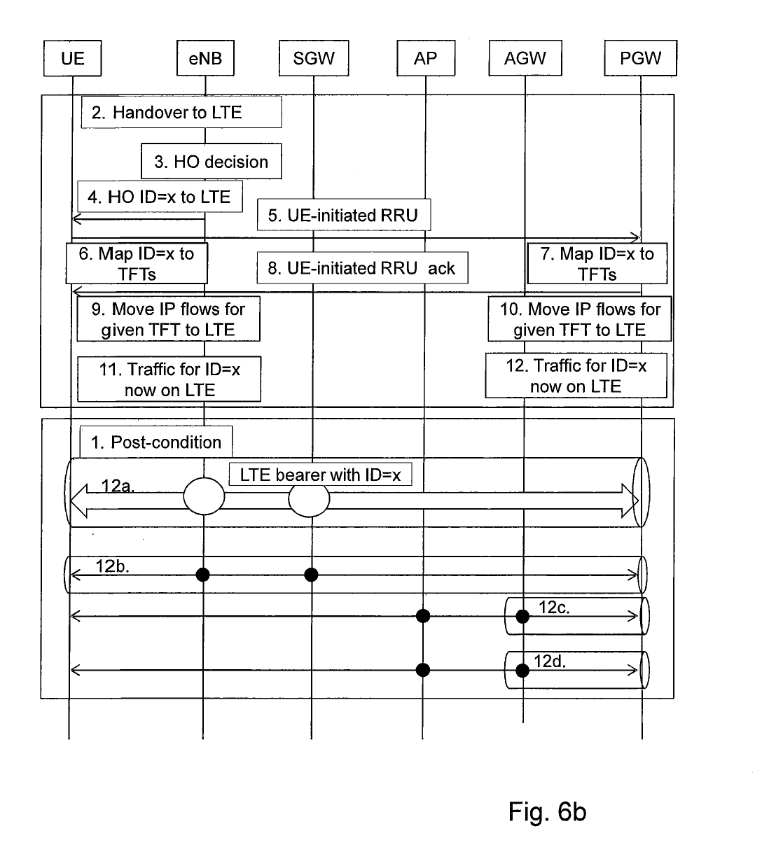

The call flow shown in FIG. 6a visualizes the embodiment D. FIG. 6a shows a handover of a UE from LTE to WLAN. AGW stands for Access Gateway and is the access gateway on the WLAN side, e.g. TWAG or ePDG. AP is the

WLAN access point. As a pre-condition, (block 1 in FIG. 6a), the UE has an IFOM PDN connection setup. There are two bearers over LTE, an LTE bearer with ID=x, 1a. in FIG. 6a) and an LTE bearer with ID=y (1b.), respectively. Symmetrical bearers have been setup over WLAN with the same TFT as their respective counterpart in LTE. These symmetrical bearers are denoted with ID=x' (1c.) and ID=y' (1d.), respectively. In this particular example, there is traffic flowing over the LTE bearer with ID=x, which is visualized with a thicker arrow (1a). Note that the bearer concept over the WLAN side is only between the PGW and the AGW. On the air link, i.e. between UE and AGW, there are no bearers defined. The bearers are visualized by the “pipes” in the figure.

Block 2 in FIG. 6a describes the actual handover to WLAN. The eNB makes the decision to perform the handover of bearer ID=x from LTE to WLAN, step 3, and sends a command to the UE to handover bearer ID=x to WLAN step 4. The UE then initiates a routing rule update procedure by sending a routing rule update, e.g. an IP flow mobility routing rule update (bearer ID=x to WLAN), step 5. The routing rule update as such is not novel; see the background information for a more complete description of this procedure. A novel thing here is that the UE requests IP flow(s) of a specific bearer to be handed over, not just a set of IP flows. Both the PGW and the UE then map the bearer ID=x to the TFTs of that bearer, steps 6 and 7. After mapping, the PGW sends an acknowledgement (step 8) to the UE, acknowledging the routing rule update. Thereafter, the PGW and the UE perform the handover, steps 9 and 11, i.e. moves the IP flows for the given TFTs to WLAN. After the handover, traffic for ID=x is flowing (steps 10 and 12) over the symmetrical bearer on WLAN with ID=x′ (shown in block 13).

In the other handover direction, i.e. from WLAN to LTE, the procedure is similar, see FIG. 6b. The procedure may continue after FIG. 6a when the IP flow has been handed over to WLAN to handover the IP flow back to LTE again. The procedure of 6b essentially follows the same setup as the procedure of FIG. 6a. Same number deals with the same or corresponding action. Note that the UE can indicate traffic for bearer ID=x to be handed over. The UE does not need to know the ID of the WLAN side, ID=x′. Due to the symmetrical-ness between x and x′, the PGW and UE know which IP flows to move. As a post-condition, the traffic flows over the LTE bearer ID=x again.

RAN-controlled bearer-based handover in embodiment B

In embodiment B (FIG. 5b), a RAN-controlled bearer-based handover may be achieved as follows. A control entity in RAN may decide that a particular bearer is to be handed over from LTE to WLAN. RAN sends a command “handover bearer ID=x to WLAN” (step 2 in embodiment B). Such command may be sent from eNB to the PGW, for example via MME, MME forwards the command to Serving Gateway, SGW, and SGW forwards the command to PGW. The PGW could then map the ID=x of this bearer to the TFT of this bearer. The PGW could perform a network-initiated IFOM routing rule update towards the UE (step 3 in embodiment B). The routing rule update includes the set of IP flows of the TFT and an indication that these flows are to be handed over to WLAN. After acknowledgement from the UE, both UE and PGW will route all IP flows associated with the bearer indicated by the RAN control entity over WLAN.

The RAN control entity mentioned above is aware of the bearers over LTE radio and S1. If such control entity is also aware of bearers over S2a/S2b, then the same procedure can be performed in the other direction. The RAN control entity may decide that a particular bearer with ID=y over S2a/S2b is to be handed over from WLAN to LTE using the same procedure as above. The handover command may be sent via S2a/S2b to the PGW. However, if the RAN control entity is not aware of the bearers over S2a/S2b, e.g. because the entity has no interface towards the TWAG/ePDG, then a WLAN-to-LTE handover cannot be controlled by RAN because RAN is not aware of the identifier of the S2a/S2b bearer.

With the concept of symmetrical bearers, the RAN control entity is able to instruct a WLAN-to-LTE handover, even if the control entity has no notion of S2a/S2b bearers. The control entity could, in the example above, simply store a relation “traffic for bearer ID=x currently on WLAN”. When a decision is made in the RAN to “take back” the traffic of that bearer to LTE, e.g. when there is available bandwidth, then the control entity sends a command “handover bearer ID=x to LTE” (step 2 in embodiment B). The rest of the procedure is the same as described above. The PGW maps ID=x to the TFT of that bearer. Due to the symmetrical-ness, there is a corresponding bearer with ID=x' on S2a/S2b with the same TFT. So the routing rule update that is sent from PGW to UE will ensure that all traffic from the S2a/S2b bearer with ID=x' is moved to the S1/LTE bearer with ID=x. After handover, the control entity updates the relation to “traffic for bearer ID=x currently on LTE”. The call flows for embodiment B would be very similar to the call flows for embodiment D. The difference is that a network-initiated IFOM routing rule update procedure would be used, instead of a UE-initiated IFOM routing rule update procedure.

RAN-controlled bearer-based handover in embodiment A

The procedure for embodiment B can also be applied to embodiment A (FIG. 5a), with the difference that the MME does the mapping from bearer ID to TFT when it receives a handover command from the RAN control entity. The MME then sends the TFT to the PCRF (step 1), as the PCRF is not aware of any bearers. The PCRF sends the TFT to the PGW (step 2). The PGW could then perform a network-initiated IFOM routing rule update towards the UE (step 3).

Uniqueness of TFT

Note that, in the embodiments above, the PGW finds the symmetrical bearer based on comparing TFTs. In particular, within an IFOM PDN connection, the TFT of a bearer in a first access is compared to the TFT of a bearer in a second access. The procedure only works if all bearers within a PDN connection and access have a unique TFT. In EPC it is the PGW that establishes and modifies bearers, so the PGW has the responsibility to maintain TFT uniqueness.

UE Support

The embodiments above require a certain UE support. First of all, the UE needs to be capable to handle UE-initiated (embodiment D) or network-initiated (embodiment B) routing rules. These procedures are currently being studied in the 3GPP SA2 IFOM work item. Secondly, in embodiment D, the UE needs to be capable to receive a handover command. This has been studied in the 3GPP Rel-12 RAN2 WiFi interworking work item and may be added to standards in 3GPP Rel-13. Thirdly, in embodiment D, the UE needs to send a routing rule update triggered by a handover command. In this document, we assume that if the UE sends a routing rule update with a set of IP flows, then the PGW can match this to exactly one bearer's TFT within the PDN connection.

IFOM Awareness in RAN Control Entity

The embodiments above may require that the RAN control entity is aware that the bearer that is to be handed over is contained within an IFOM PDN connection. There are several ways to create this awareness. One way would be to add a flag in the bearer setup/modify procedure indicating “IFOM”. Such flag would be set by the PGW and sent to the RAN control entity e.g. via SGW and MME to the eNB in the case when the RAN control entity is within the eNB. The eNB may also forward the “IFOM” indication to the RAN control entity in the case when this entity is not within the eNB.

The embodiments above can be optimized. Assume the RAN controls the 3GPP access and thereby knows of all bearers for this UE over that access. The symmetrical (dedicated) bearer over the WLAN access does then not need to be setup until the bearer is moved to WLAN. Similarly, once there is a symmetrical bearer over WLAN, and the traffic is moved back to 3GPP, then the (dedicated) bearer over WLAN can be removed.

According to an embodiment, a method is provided in a gateway serving an IFOM PDN connection towards a UE, the connection being routed over a plurality of access networks, where the gateway maintains a symmetrical bearer setup across all accesses of the connection, the gateway: receiving a request to handover IP flows associated with a bearer in one of the accesses of the IFOM PDN connection, the command including an identifier of the said bearer and a target access within the plurality of access network of the connection and routing all IP flows associated with the said bearer to the bearer in the target access that is symmetrical to the said bearer. The identifier may be one of an EPS Bearer

Identity as defined in TS 23.401 and a TFT unique to one bearer on the said access;

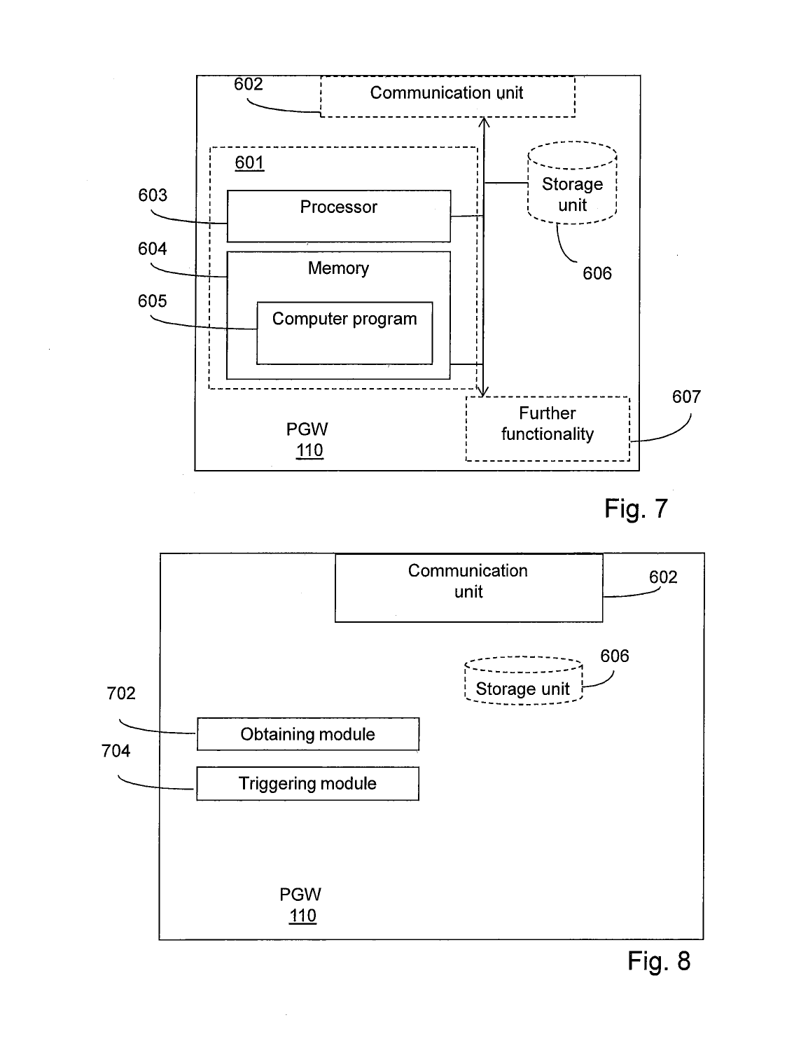

According to another embodiment as shown in FIG. 7, a PGW 110 is provided, operable in a communication network comprising a 3GPP access network and a non-3GPP access network, and wherein, for a UE 120, an IP flow mobility PDN connection is set up towards the communication network. The PGW comprises a processor 603 and a memory 604. The memory contains instructions executable by said processor, whereby the PGW 110 is operative for obtaining information that for the IP flow mobility PDN connection, there is a first bearer in a first access network, which first bearer has an access parameter with a first value, the first access network being either the non-3GPP access network or the 3GPP access network, and, when, for the IP flow mobility PDN connection, there is no bearer that has an access parameter with the first value in a second access network, triggering setup of a second bearer in the second access network that has an access parameter with the first value, the second access network being either the non-3GPP access network or the 3GPP access network but not the same access network as the first access network.

According to an embodiment, said memory 604 contains instructions executable by said processor 603, whereby the PGW 110 is further operative for, s in response to the set-up of the second bearer with the first value, associating the first bearer of the first access network with the second bearer of the second access network.

According to another embodiment, said memory 604 contains instructions executable by said processor 603, whereby the PGW 110 is further operative for, after the first bearer has been associated with the second bearer, obtaining information that the first bearer has been removed, and triggering removal of the second bearer in response to the obtained information.

According to another embodiment, said memory 604 contains instructions executable by said processor 603, whereby the PGW 110 is further operative for, after the first bearer has been associated with the second bearer, obtaining information that the access parameters value of the first bearer has been changed to a second value, and in response to the obtained change information, modifying the access parameters value of the second bearer from the first value to the second value.

According to another embodiment, said memory 604 contains instructions executable by said processor 603, whereby the PGW 110 is further operative for receiving a handover command from a 3GPP access network node to handover IP flows associated with the first bearer of the first access network to the second access network, the handover command containing an indicator identifying the first bearer and a second access network indicator, and mapping the received indicator identifying the first bearer to the first access parameter value. The PGW 110 is further operative for sending an IP flow handover request to the UE, instructing the UE to start sending IP flows matching the first access parameter value to the second access network according to the second access network indicator, and when receiving an IP flow matching the first access parameter value, routing this IP flow on the second bearer of the second access network, the second bearer having the first access parameter value.

According to another embodiment, said memory 604 contains instructions executable by said processor 603, whereby the PGW 110 is further operative for receiving an IP flow handover request from the UE to handover IP flows associated with the first bearer of the first access network to the second access network, the handover request containing an indicator identifying the first bearer and a second access network indicator, and mapping the received indicator identifying the first bearer to the first access parameter value. The PGW 110 is further operative for sending an acknowledgement to the UE, instructing the UE to start sending IP flows matching the first access parameter value to the second access network, and when receiving an IP flow matching the first access parameter value, routing this IP flow on the second bearer having the first access parameter value.

The PGW 110 may further comprise a communication unit 602, which may be considered to comprise conventional means for communicating from and/or to the other nodes in the network, such as the Serving Gateway, the TWAG/ePDG, the PCRF. The communication unit 602 may also be used for communication to and from the UE, via the network nodes. The conventional communication means may include at least one communication port. The PGW may further comprise one or more storage units 606 and further functionality 607 useful for the PGW to serve its purpose as PGW. The instructions executable by said processor may be arranged as a computer program 605 stored in said memory 604. The processor 603 and the memory 604 may be arranged in an arrangement 601. The arrangement 601 may be a micro processor and adequate software and storage therefore, a Programmable Logic Device, PLD, or other electronic component(s)/processing circuit(s) configured to perform the actions, or methods mentioned above.

The computer program 605 may comprise computer readable code means, which when run in the PGW 110 causes the PGW to perform the steps described in any of the described embodiments. The computer program may be carried by a computer program product connectable to the processor. The computer program product may be the memory 604. The memory 604 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 604. Alternatively, the computer program may be stored on a server or any other entity connected to the communication network to which the PGW has access via its communication unit 602. The computer program may then be downloaded from the server into the memory 604.

FIG. 8 shows another embodiment of a PGW 110 operable in a communication network comprising a 3GPP access network and a non-3GPP access network, and wherein, for a UE, an IP flow mobility Packet Data Network, PDN, connection is set up towards the communication network. The PGW 110 comprises an obtaining module 702 for obtaining information that for the IP flow mobility PDN connection, there is a first bearer in a first access network, which first bearer has an access parameter with a first value, the first access network being either the non-3GPP access network or the 3GPP access network. The PGW further comprises a triggering module 704 for triggering setup of a second bearer in the second access network that has an access parameter with the first value, when, for the IP flow mobility PDN connection, there is no bearer that has an access parameter with the first value in a second access network, the second access network being either the non-3GPP access network or the 3GPP access network but not the same access network as the first access network.

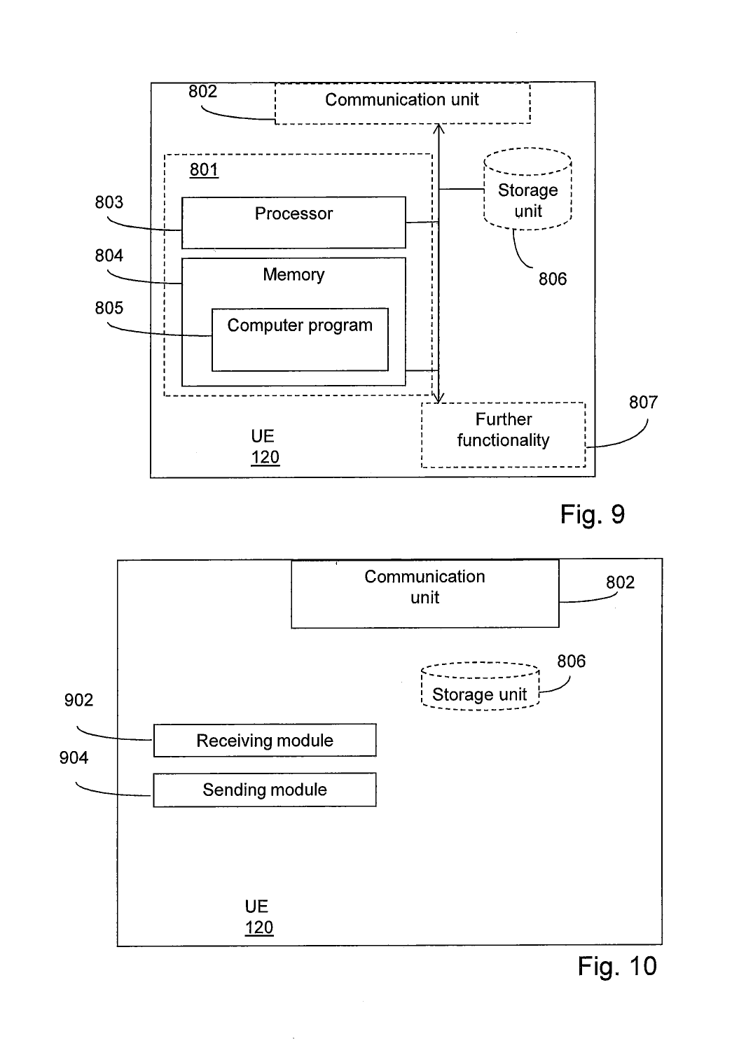

According to another embodiment as shown in FIG. 9, a UE 120 is provided configured to communicate with a communication network comprising a 3GPP access network and a non-3GPP access network, the UE having an IP flow mobility PDN connection set up towards the communication network. For the IP flow mobility PDN connection there is a first bearer in a first access network, which first bearer has an access parameter with a first value, the first access network being the 3GPP access network, and a second bearer in a second access network that has an access parameter with the first value, the second access network being the non-3GPP access network. The UE comprises a processor 803 and a memory 804, said memory containing instructions executable by said processor, whereby the UE 120 is operative for receiving a handover command from a 3GPP access network node to handover IP flows associated with the first bearer of the first access network to a target access network, the target access network being either the 3GPP access network or the non-3GPP access network, the handover command containing an indicator identifying the first bearer and a target access network indicator; and in response to the received handover command, sending an IP Flow handover request to a PDN gateway, instructing the PDN gateway to start sending IP flows associated with the first bearer to the target access network.

According to an embodiment, the sent handover request contains the indicator identifying the first bearer and the target access network indicator.

According to another embodiment, said memory 804 contains instructions executable by said processor 803, whereby the UE 120 is further operative for mapping the received indicator identifying the first bearer to the first access parameter value.

According to another embodiment, said memory 804 contains instructions executable by said processor 803, whereby the UE 120 is further operative for receiving an acknowledgement from the PDN Gateway in response to the sent IP Flow handover request, and sending an IP flow matching the first access parameter value to the target access network, in response to the received acknowledgement.

The UE 120 may further comprise a communication unit 802, which may be considered to comprise conventional means for communicating from and/or to the other nodes in the network, such as an access point in a non-3GPP network and an eNodeB in a 3GPP network. The communication unit 802 may also be used for communication to and from the PDN gateway, via the network nodes. The conventional communication means may include at least one transmitter and at least one receiver. The UE may further comprise one or more storage units 806 and further functionality 807 useful for the UE to serve its purpose as UE, such as a battery. The instructions executable by said processor may be arranged as a computer program 805 stored in said memory 804. The processor 803 and the memory 804 may be arranged in an arrangement 801. The arrangement 801 may be a micro processor and adequate software and storage therefore, a

Programmable Logic Device, PLD, or other electronic component(s)/processing circuit(s) configured to perform the actions, or methods mentioned above.

The computer program 805 may comprise computer readable code means, which when run in the UE 120 causes the UE to perform the steps described in any of the described embodiments. The computer program may be carried by a computer program product connectable to the processor. The computer program product may be the memory 804. The memory 804 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 804. Alternatively, the computer program may be stored on a server or any other entity connected to the communication network to which the UE has access via its communication unit 802. The computer program may then be downloaded from the server into the memory 804.

FIG. 10 shows another embodiment of a UE 120 configured to communicate with a communication network comprising a 3GPP access network and a non-3GPP access network. The UE has an IP flow mobility PDN connection set up towards the communication network. For the IP flow mobility PDN connection there is a first bearer in a first access network, which first bearer has an access parameter with a first value, the first access network being the 3GPP access network, and a second bearer in a second access network that has an access parameter with the first value, the second access network being the non-3GPP access network. The UE comprises a receiving module 902 for receiving a handover command from a 3GPP access network node to handover IP flows associated with the first bearer of the first access network to a target access network, the target access network being either the 3GPP access network or the non-3GPP access network, the handover command containing an indicator identifying the first bearer and a target access network indicator. The UE further comprises a sending module for sending an IP Flow handover request to a PDN gateway in response to the received handover command, instructing the PDN gateway to start sending IP flows associated with the first bearer to the target access network.

Even though the description has been focused on LTE-WLAN handover it is applicable to any kind of 3GPP access network to/from non-3GPP access network handover, for example, it is applicable to a UTRAN-WLAN handover or LTE-CDMA2000 handover.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby.

1. A method performed by a packet data network gateway, PGW, for improving handover in a communication network comprising a 3GPP access network and a non-3GPP access network, and wherein, for a UE, an IP flow mobility Packet Data Network, PDN, connection is set up towards the communication network, the method comprising:
obtaining information that for the IP flow mobility PDN connection, there is a first bearer in a first access network, which first bearer has an access parameter with a first value, the first access network being either the non-3GPP access network or the 3GPP access network;
when, for the IP flow mobility PDN connection, there is no bearer that has an access parameter with the first value in a second access network, triggering setup of a second bearer in the second access network that has an access parameter with the first value, the second access network being either the non-3GPP access network or the 3GPP access network but not the same access network as the first access network.

2. Method according to claim 1, further comprising, in response to the set-up of the second bearer with the first value:
associating the first bearer of the first access network with the second bearer of the second access network.

3. Method according to claim 2, further comprising, after the first bearer has been associated with the second bearer:
obtaining information that the first bearer has been removed; and
triggering removal of the second bearer in response to the obtained information.

4. Method according to claim 2, further comprising, after the first bearer has been associated with the second bearer:
obtaining information that the access parameters value of the first bearer has been changed to a second value, and
in response to the obtained change information, modifying the access parameters value of the second bearer from the first value to the second value.

5. Method according to claim 1, further comprising:
receiving a handover command from a 3GPP access network node to handover IP flows associated with the first bearer of the first access network to the second access network, the handover command containing an indicator identifying the first bearer and a second access network indicator,
mapping the received indicator identifying the first bearer to the first access parameter value,
sending an IP flow handover request to the UE, instructing the UE to start sending IP flows matching the first access parameter value to the second access network according to the second access network indicator, and
when receiving an IP flow matching the first access parameter value, routing this IP flow on the second bearer of the second access network, the second bearer having the first access parameter value.

6. Method according to claim 5, wherein the handover command is received from a radio access network node of the 3GPP access network.

7. Method according to claim 5, wherein the handover command is received from a Policy and Charging Rule Function, PCRF, of the 3GPP network.

8. Method according to claim 1, further comprising:
receiving an IP flow handover request from the UE to handover IP flows associated with the first bearer of the first access network to the second access network, the handover request containing an indicator identifying the first bearer and a second access network indicator,
mapping the received indicator identifying the first bearer to the first access parameter value,
sending an acknowledgement to the UE, instructing the UE to start sending IP flows matching the first access parameter value to the second access network, and
when receiving an IP flow matching the first access parameter value, routing this IP flow on the second bearer having the first access parameter value.

9. A method for improving handover performed by a user equipment, UE configured to communicate with a communication network comprising a 3GPP access network and a non-3GPP access network, the UE having an IP flow mobility Packet Data Network, PDN, connection set up towards the communication network, and for the IP flow mobility PDN connection there is a first bearer in a first access network, which first bearer has an access parameter with a first value, the first access network being the 3GPP access network, and a second bearer in a second access network that has an access parameter with the first value, the second access network being the non-3GPP access network, the method comprising:
receiving a handover command from a 3GPP access network node to handover IP flows associated with the first bearer of the first access network to a target access network, the target access network being either the 3GPP access network or the non-3GPP access network, the handover command containing an indicator identifying the first bearer and a target access network indicator; and
in response to the received handover command, sending an IP Flow handover request to a PDN gateway, instructing the PDN gateway to start sending IP flows associated with the first bearer to the target access network.

10. Method according to claim 9, wherein the sent handover request contains the indicator identifying the first bearer and the target access network indicator.

11. Method according to claim 9, further comprising:
Mapping the received indicator identifying the first bearer to the first access parameter value

12. Method according to claim 9, further comprising:
receiving an acknowledgement from the PDN Gateway in response to the sent IP Flow handover request, and
sending an IP flow matching the first access parameter value to the target access network, in response to the received acknowledgement.

13. A packet data network gateway, PGW, operable in a communication network comprising a 3GPP access network and a non-3GPP access network, and wherein, for a UE, an IP flow mobility Packet Data Network, PDN, connection is set up towards the communication network, the PGW comprising a processor and a memory, said memory containing instructions executable by said processor, whereby the PGW is operative to:
obtaining information that for the IP flow mobility PDN connection, there is a first bearer in a first access network, which first bearer has an access parameter with a first value, the first access network being either the non-3GPP access network or the 3GPP access network; and
when, for the IP flow mobility PDN connection, there is no bearer that has an access parameter with the first value in a second access network, triggering setup of a second bearer in the second access network that has an access parameter with the first value, the second access network being either the non-3GPP access network or the 3GPP access network but not the same access network as the first access network.

14. PGW according to claim 13, wherein said memory contains instructions executable by said processor, whereby the PGW is further operative to, in response to the set-up of the second bearer with the first value, associating the first bearer of the first access network with the second bearer of the second access network.

15. PGW according to claim 14, wherein said memory contains instructions executable by said processor, whereby the PGW is further operative to, after the first bearer has been associated with the second bearer,
obtaining information that the first bearer has been removed, and
triggering removal of the second bearer in response to the obtained information.

16. PGW according to claim 14, wherein said memory contains instructions executable by said processor, whereby the PGW is further operative to, after the first bearer has been associated with the second bearer,
obtaining information that the access parameters value of the first bearer has been changed to a second value, and
in response to the obtained change information, modifying the access parameters value of the second bearer from the first value to the second value.

17. PGW according to claim 13, wherein said memory contains instructions executable by said processor, whereby the PGW is further operative to:
receiving a handover command from a 3GPP access network node to handover IP flows associated with the first bearer of the first access network to the second access network, the handover command containing an indicator identifying the first bearer and a second access network indicator,
mapping the received indicator identifying the first bearer to the first access parameter value,
sending an IP flow handover request to the UE, instructing the UE to start sending IP flows matching the first access parameter value to the second access network according to the second access network indicator, and
when receiving an IP flow matching the first access parameter value, routing this IP flow on the second bearer of the second access network, the second bearer having the first access parameter value.

18. PGW according to claim 13, wherein said memory contains instructions executable by said processor, whereby the PGW is further operative to:
receiving an IP flow handover request from the UE to handover IP flows associated with the first bearer of the first access network to the second access network, the handover request containing an indicator identifying the first bearer and a second access network indicator,
mapping the received indicator identifying the first bearer to the first access parameter value,
sending an acknowledgement to the UE, instructing the UE to start sending IP flows matching the first access parameter value to the second access network, and
when receiving an IP flow matching the first access parameter value, routing this IP flow on the second bearer having the first access parameter value.

19. A user equipment, UE configured to communicate with a communication network comprising a 3GPP access network and a non-3GPP access network, the UE having an IP flow mobility Packet Data Network, PDN, connection set up towards the communication network, and for the IP flow mobility PDN connection there is a first bearer in a first access network, which first bearer has an access parameter with a first value, the first access network being the 3GPP access network, and a second bearer in a second access network that has an access parameter with the first value, the second access network being the non-3GPP access network, the UE comprising a processor and a memory, said memory containing instructions executable by said processor, whereby the UE is operative to:
receiving a handover command from a 3GPP access network node to handover IP flows associated with the first bearer of the first access network to a target access network, the target access network being either the 3GPP access network or the non-3GPP access network, the handover command containing an indicator identifying the first bearer and a target access network indicator; and
in response to the received handover command, sending an IP Flow handover request to a PDN gateway, instructing the PDN gateway to start sending IP flows associated with the first bearer to the target access network.

20. UE according to claim 19, wherein the sent handover request contains the indicator identifying the first bearer and the target access network indicator.

21. UE according to claim 19, wherein said memory contains instructions executable by said processor, whereby the UE is further operative to map the received indicator identifying the first bearer to the first access parameter value.

22. UE according to claim 19, wherein said memory contains instructions executable by said processor, whereby the UE is further operative to:
receiving an acknowledgement from the PDN Gateway in response to the sent IP Flow handover request, and
sending an IP flow matching the first access parameter value to the target access network, in response to the received acknowledgement.

23.-26. (canceled)
